(19) United States
(12) Patent Application Publication
(10) Pub. No.: US 2008/0098696 A1
(43) Pub. Date: May 1, 2008

(54) Insertion apparatus and method

(76) Inventor: Kent Gallimore, Ingleside, IL (US)

Correspondence Address: PATTI, HEWITT & AREZINA LLC, ONE NORTH LASALLE STREET, 44TH FLOOR, CHICAGO, IL, 60602, US

(21) Appl. No.: 11/588,168

(22) Filed: Oct. 26, 2006

(51) Int. Cl. A21C 15/04

(52) U.S. Cl. 53/435

(57) ABSTRACT

An apparatus in one example has: a burst functionality whereby a foremost coupon is separated from a next coupon of a continuous web of coupons; a staging functionality whereby the separated foremost coupon is moved to a staging position; and an insertion functionality whereby the first coupon is inserted into a container only after the next coupon is separated from the continuous web.

### TECHNICAL FIELD

The invention relates generally to insertion devices and methods and, more specifically, to inserting a foremost coupon from a continuous coupon web into a container only after a next coupon is separated from the continuous coupon web.

### BACKGROUND

The goal of coupon inserters is to consistently place coupons into bags of cereal, candy, rice, coffee, and snack food, and into boxes and packages of pretzels, pasta, cookies, crackers, and more. Inserters operate at speeds up to 300 pieces per minute, utilizing the continuous perforated or non-perforated coupon format. Known inserters can be utilized to insert both overwrapped and non-overwrapped pieces in a bandolier or roll format.

Reliability and consistency is extremely important for coupon insertion at the high rates of speed that are required. Such reliability and consistency needs improvement in the area of coupon inserters that use a bursting operation to remove a coupon from a coupon web and then insert the coupon into a container.

Thus, there is a need in the art for an improved coupon inserter.

### SUMMARY

One embodiment of the present method and apparatus encompasses an apparatus. This embodiment of the apparatus may comprise: a burst functionality whereby a foremost coupon is separated from a next coupon of a continuous web of coupons; a staging functionality whereby the separated foremost coupon is moved to a staging position; and an insertion functionality whereby the foremost coupon is inserted into a container only after the next coupon is separated from the continuous web.

Another embodiment of the present method and apparatus encompasses a method. This embodiment of the method may comprise: bursting a foremost coupon from a next coupon of a continuous web of coupons; moving the separated foremost coupon to a staging position; and inserting the foremost coupon into a container only after the next coupon is separated from the continuous web.

### DESCRIPTION OF THE DRAWINGS

The features of the embodiments of the present method and apparatus are set forth with particularity in the appended claims. These embodiments may best be understood by reference to the following description taken in conjunction with the accompanying drawings, in the several figures of which like reference numerals identify like elements, and in which:

FIG. 1 depicts one embodiment of a continuous coupon web;

FIG. 2 depicts another embodiment of a continuous coupon web;

FIG. 3 depicts one view on an embodiment of a coupon insertion device according to the present method and apparatus;

FIG. 4 depicts another view on an embodiment of a coupon insertion device according to the present method and apparatus;

FIGS. 5-12 depict operation according to the present method and apparatus for inserting a coupon into a container; and

FIG. 13 depicts another embodiment of a coupon insertion device according to the present method and apparatus.

### DETAILED DESCRIPTION

Inserts and containers containing the inserts are well known. An insert may take various forms and may be any coupon, card, sheet, receipt, warranty, premium or other part that may be advantageously handled as described hereinafter. In the following the term “coupon” will be used as representative of any form of an insert. Also, an insert may be two-dimensional or three-dimensional. Furthermore, a container may be any type of container, such as boxes, tubs, cans and vessels of all kinds as well as any other coupon-receiver which can advantageously be used as described hereinafter.

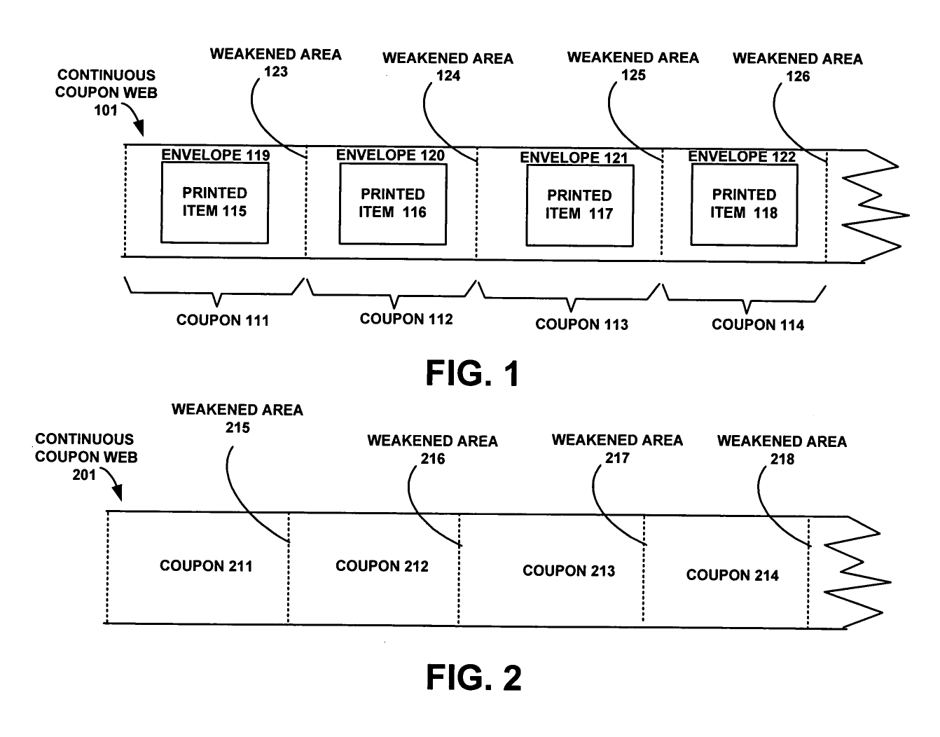

FIG. 1 depicts one embodiment of a continuous coupon web. In this embodiment the coupons 111-114 may be contained in a continuous web 101. Each coupon 111-114 may comprise, for example, a printed item 115-118 respectively enclosed in an envelope 119-122 (also referred to as an overwrap), which may be made of cellophane, plastic, etc. The coupons 111-114 may be temporarily coupled to one another via a perforated or weakened areas 123-126.

FIG. 2 depicts another embodiment of a continuous coupon web 201. In this embodiment coupons 211-214 are coupled to one another by perforated or weakened areas 215-218. Other materials and configurations of the coupons may be utilized. Typically, the continuous coupon web 201 may be stored on a reel or may have a fan-fold configuration and be stored in a box.

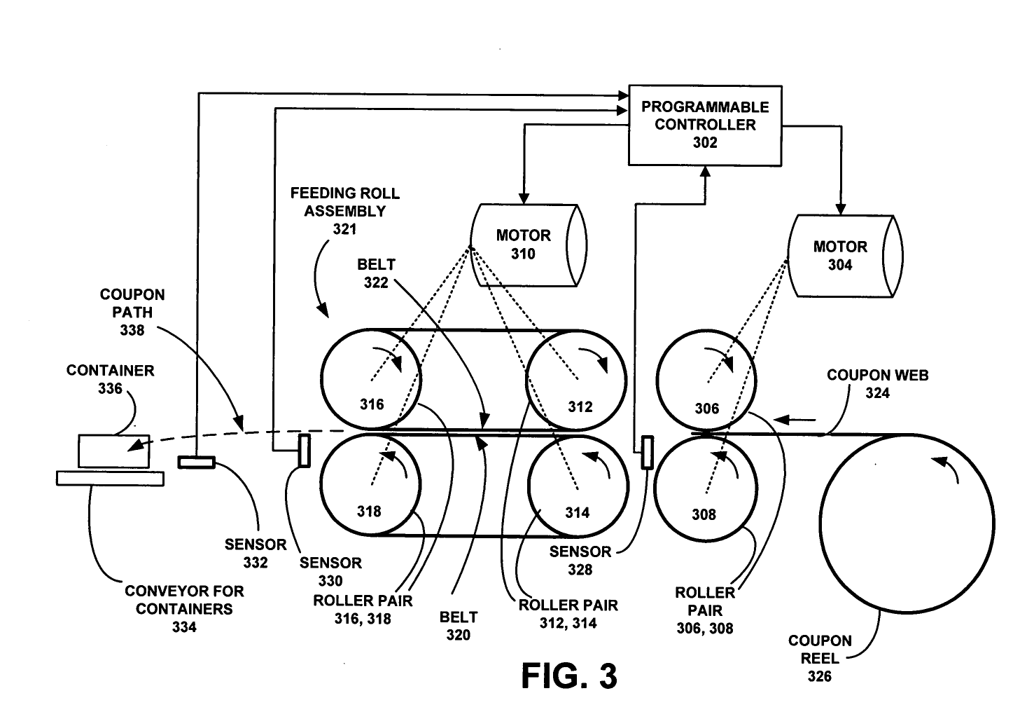

FIG. 3 depicts one view on an embodiment of a coupon insertion device according to the present method and apparatus. In this embodiment a positioning roll pair, which includes rollers 306, 308, may receive a leading edge of a foremost coupon of a coupon web 324, and may be driven by an intermittent positioning drive motor 304 at a predetermined speed. A feeding roll assembly 321 may be formed by a roller pair 312, 314, roller pair 316, 318, and belts 320, 322. The positioning roll pair 306, 308 and the feeding roll assembly 321 may be controlled to separate the foremost coupon from a next coupon of the continuous web 324 by stopping or slowing the positioning roll pair 306, 308 relative to the feeding roll assembly 321 to effect a bursting operation. The feeding roll assembly 321 may be located upstream of the positioning roll pair 306, 304, and may be driven by an intermittent feeding drive motor 310.

A programmable controller 302 or other equivalent control device may be operatively coupled to the motors 304 and 310. In general the programmable controller may be programmed such that the embodiment depicted in FIG. 3 may have: a burst functionality whereby a foremost coupon is separated from a next coupon of a continuous web of coupons; a staging functionality whereby the separated foremost coupon is moved to a staging position; and an insertion functionality whereby the first coupon is inserted into a container only after the next coupon is separated from the continuous web.

The programmable controller 302 may be coupled to first sensor 328, second sensor 330 and third sensor 332. The first sensor 328, the second sensor 330 and the third sensor 332 may form a coupon sensing assembly. The first sensor 328 detects the positions of the coupons that are attached to the coupon web 324 that may be stored on a coupon reel 326. Information from the first sensor 328 may be utilized for effecting the burst functionality and the staging functionality. The second sensor 330 is optional and may be used to detect that a separated foremost coupon has departed the feeding roll assembly 321.

The third sensor 322 detects a container 336 on a conveyor for containers 334. Information from the third sensor 334 may be utilized in effecting the insertion functionality whereby a foremost coupon is inserted into a container only after a next coupon is separated from the continuous web. A coupon may be ejected from the feeding roll assembly 321 along coupon path 338 and into container 336 as the container 336 travels along the conveyor for containers 334. This results in increased reliability and operation of inserting coupons in containers.

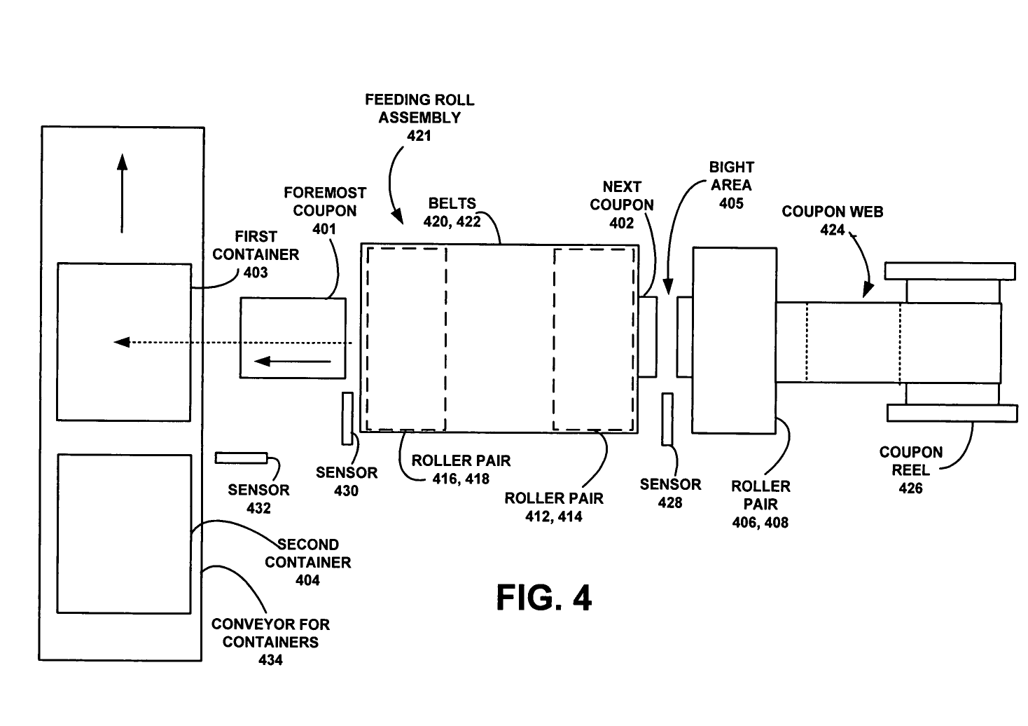

FIG. 4 depicts another view of the FIG. 3 embodiment of a coupon insertion device according to the present method and apparatus. A coupon web 424 is supplied from a coupon reel 426 to roller pair 406, 408. A bight area 405 is defined between the roller pair 406, 408 and the feeding assembly 421 that is formed by roller pair 412, 414, roller pair 416, 418, and belts 420, 422. Sensors 428, 430 and 432 operate as described above in FIG. 3.

As depicted in FIG. 4 a foremost coupon 401 is being ejected from the feeding assembly 421 toward an approaching first container 403 on a conveyor for containers 434. Before the foremost coupon 401 reaches the first container 403, the next coupon 402 is separated from the coupon web 424. This next coupon 424 will eventually be inserted into the second container 404.

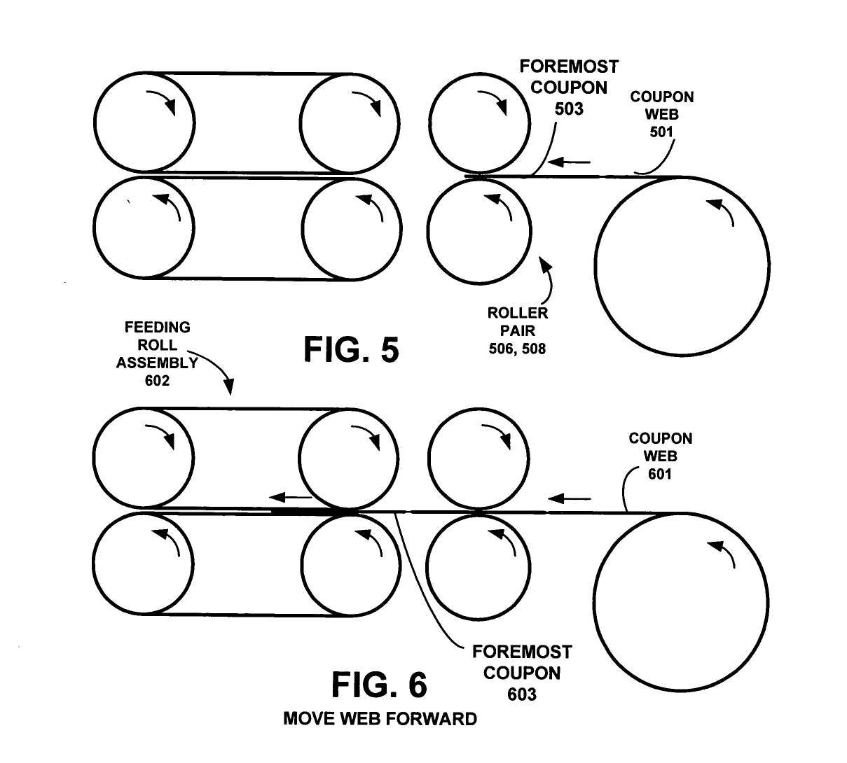

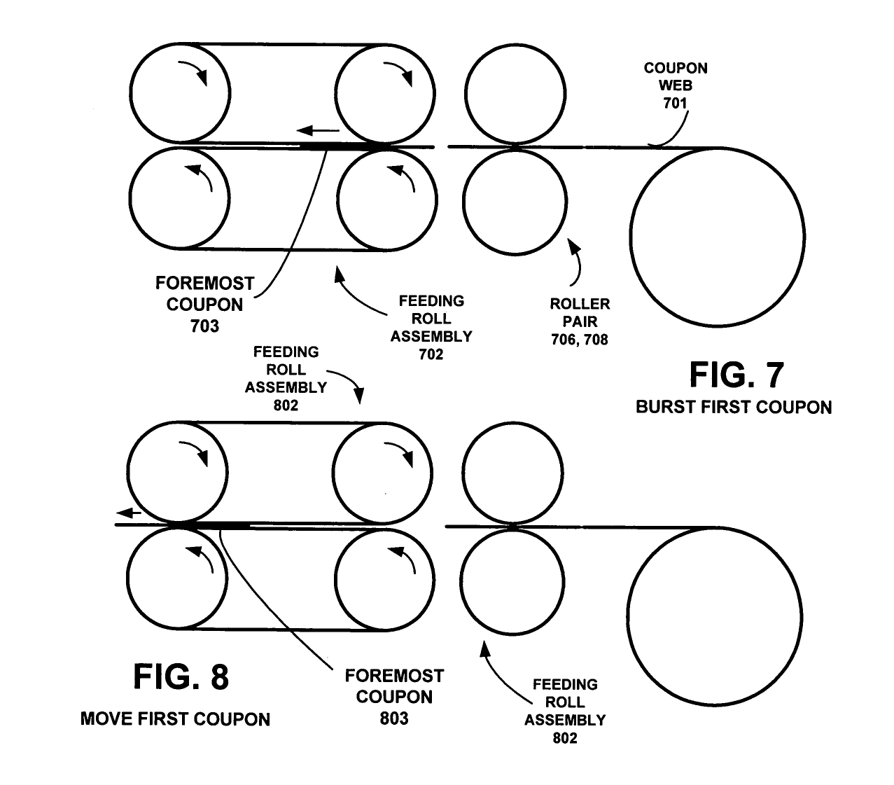

FIGS. 5-12 depict operation according to the present method and apparatus for inserting a coupon into a container. In FIG. 5 a foremost coupon 503 of the coupon web 501 is received by roller pair 506, 508. In FIG. 6 the foremost coupon on the coupon web 601 is advanced into the feeding roll assembly 602. In FIG. 7 the foremost coupon 703 is separated from the coupon web 701 in a bursting operation effected by the feeding roll assembly 702 and the roller pair 706, 708. In FIG. 8 the feeding roll assembly 802 advances the foremost coupon 803.

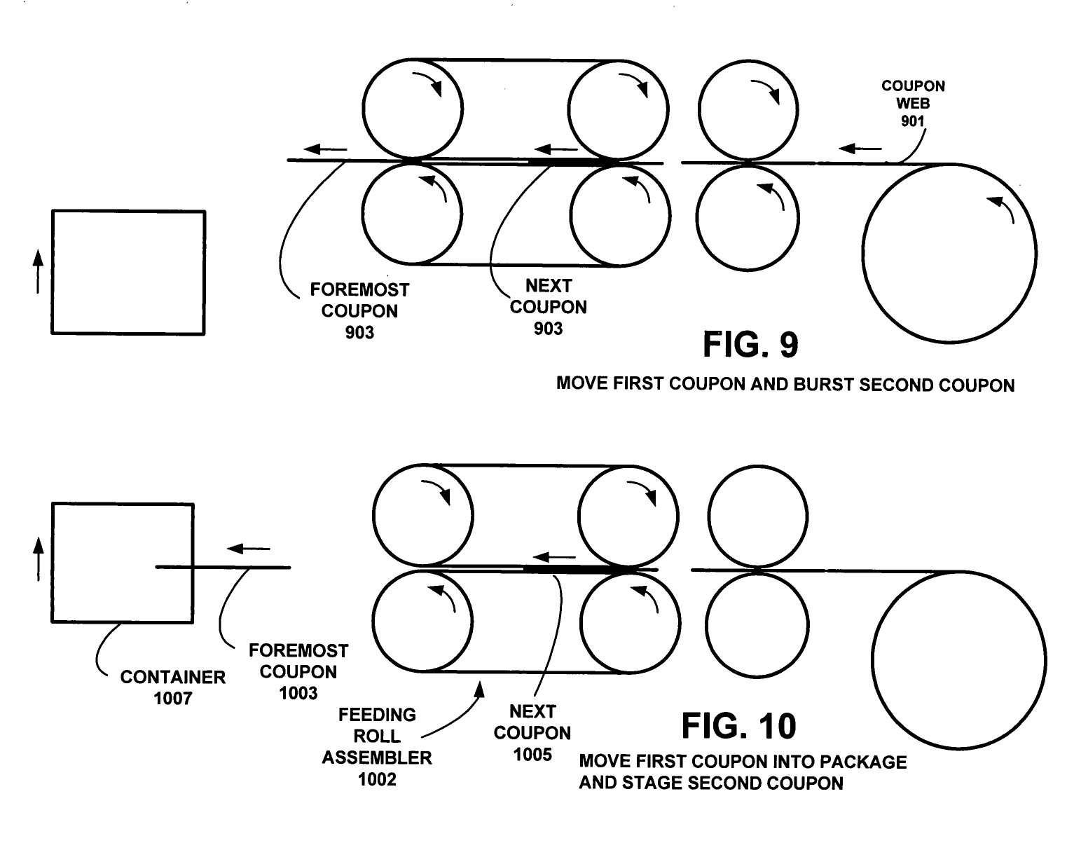

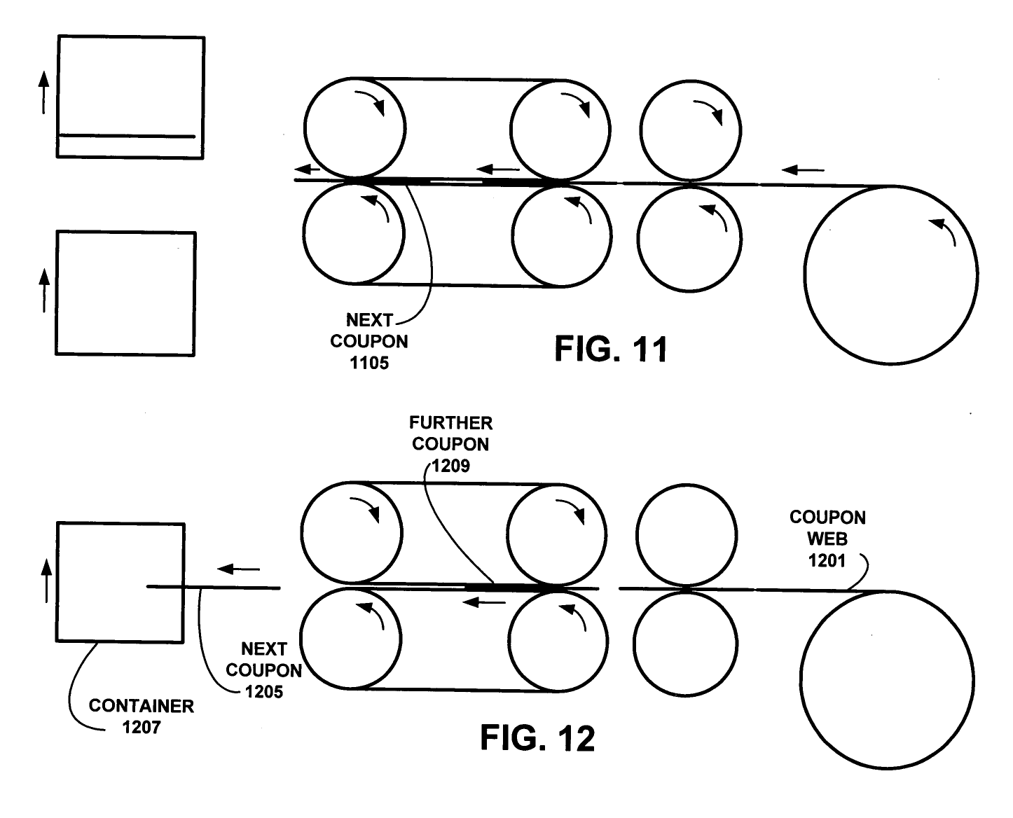

In FIG. 9 the foremost coupon 903 is moved to a staging position and the next coupon 905 is separated from the coupon web 901 in a bursting operation. In FIG. 10 the foremost coupon 1003 is being inserted into a container 1007 while the next coupon 1005 is moved through the feeding roll assembly 1002. In FIG. 11 the next coupon 1103 continues to move through the staging position while the coupon web is moved into position for a bursting operation. In FIG. 12 the next coupon 1205 is inserted into the container 1207 after a further coupon 1209 has been separated from the coupon web 1201 in a bursting operation.

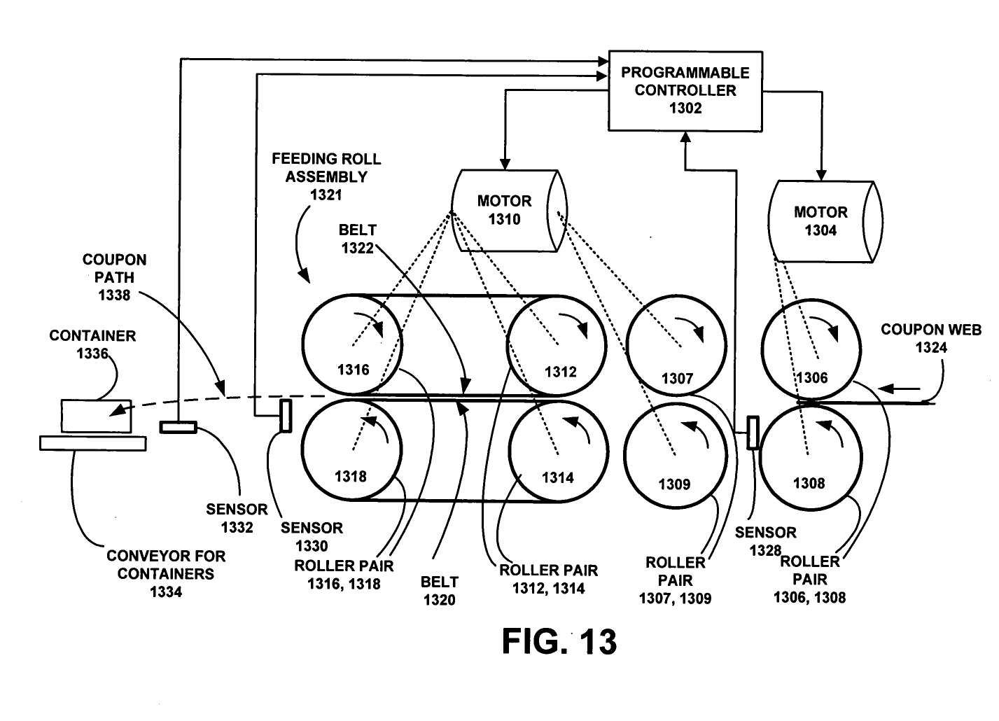

FIG. 13 depicts another embodiment of an insertion device according to the present method and apparatus. In this embodiment a first roller pair, which includes rollers 1306, 1308, may receive a leading edge of a foremost coupon of a coupon web 1324, and may be driven by an intermittent positioning drive motor 1304 at a predetermined speed. A second roll pair, which includes rollers 1307, 1309, may define a bight area between the first roller pair 1306, 1308 and the second roller pair 1307, 1309, and may be driven by an intermittent positioning drive motor 1310 at a predetermined speed. The first roller pair 1306, 1308 and the second roller pair 1307, 1309 may be controlled to separate the foremost coupon from a next coupon of the continuous web 1324 in a burst operation. The coupon web 1324 may be stored, for example, on a reel or in a fan-fold configuration in a box.

The feeding roll assembly 1321 may be formed by a roller pair 1312, 1314, roller pair 1316, 1318, and belts 1320, 1322. The feeding roll assembly 1321 may be located downstream of the first roller pair 1306, 1304, and may be driven by the intermittent feeding drive motor 1310.

A programmable controller 1302 or other equivalent device may be operatively coupled to the motors 1304 and 1310. In general the programmable controller may be programmed such that the embodiment depicted in FIG. 13 may have: a burst functionality whereby a foremost coupon is separated from a next coupon of a continuous web of coupons; a staging functionality whereby the separated foremost coupon is moved to a staging position; and an insertion functionality whereby the first coupon is inserted into a container only after the next coupon is separated from the continuous web.

The programmable controller 1302 may be coupled to first sensor 1328, second sensor 1330 and third sensor 1332. The first sensor 1328, the second sensor 1330 and the third sensor 1332 may form a coupon sensing assembly. The first sensor 1328 detects the positions of the coupons that are attached to the coupon web 1324 that may be stored on a coupon reel 1326. Information from the first sensor 1328 may be utilized for effecting the burst functionality. The second sensor 1330 detects a separated foremost coupon in the staging position. Information from the second sensor 1330 may be utilized in effecting the staging functionality.

The third sensor 1322 detects a container 1336 on a conveyor for containers 1334. Information from the third sensor 1334 may be utilized in effecting the insertion functionality whereby a foremost coupon is inserted into a container only after a next coupon is separated from the continuous web. A coupon may be ejected from the feeding roll assembly 1321 along coupon path 1338 and into container 1336 as the container 1336 travels along the conveyor for containers 1334. This results in increased reliability and operation of inserting coupons in containers.

The programmable controller 302 may be coupled to first sensor 328, second sensor 330 and third sensor 332. The first sensor 328, the second sensor 330 and the third sensor 332 may form a coupon sensing assembly. The first sensor 328 detects the positions of the coupons that are attached to the coupon web 324 that may be stored on a coupon reel 326. Information from the first sensor 328 may be utilized for effecting the burst functionality and the staging functionality. The second sensor 330 is optional and may be used to detect that a separated foremost coupon has departed the feeding roll assembly 321.

The third sensor 1322 detects a container 1336 on a conveyor for containers 1334. Information from the third sensor 1334 may be utilized in effecting the insertion functionality whereby a foremost coupon is inserted into a container only after a next coupon is separated from the continuous web. A coupon may be ejected from the feeding roll assembly 1321 along coupon path 1338 and into container 1336 as the container 1336 travels along the conveyor for containers 1334.

In one embodiment operation of the FIG. 13 apparatus my function as follows. The coupon web 1324 is fed between the first roller pair 1306, 1304 until a leading edge of the coupon web 1324 reaches the first sensor 1328. During on going operation a foremost coupon will be at a staging position within the feeding roll assembly 1321, and a next coupon will be at the first sensor 1328 with both drive motors 1304 and 1310 stopped.

When the third sensor 1332 detects an approaching container 1336, both motors are activated and the foremost coupon is moved through and out of the feeding roll assembly 1321, and the next coupon is move into the second roller pair 1307, 1309. The first roller pair 1306, 1304 is then slowed or stopped to separate the next coupon from the coupon web 1324. After the next coupon has been separated from the coupon web 1324, the foremost coupon enters the container 1336 in the insertion operation as the next coupon is moved to the staging position in the feeding roll assembly 1321. The feeding drive motor 1310 is then stopped. The process then repeats upon receiving another signal from the third sensor 1332.

The present apparatus in one example may comprise a plurality of components such as one or more of electronic components, hardware components, and computer software components. A number of such components may be combined or divided in the apparatus.

The present apparatus may employ at least one computer-readable signal-bearing media that may store software, firmware and/or assembly language, etc. The computer-readable signal-bearing medium may comprise magnetic, electrical, optical, biological, and/or atomic data storage mediums. For example, the computer-readable signal-bearing medium may comprise floppy disks, magnetic tapes, CD-ROMs, DVD-ROMs, hard disk drives, and electronic memories, etc. The computer-readable signal-bearing medium may also comprise a modulated carrier signal transmitted over a network comprising or coupled with the apparatus, for instance, at least one of a telephone network, a local area network (“LAN”) such as Ethernet, a wide area network (“WAN”), the Internet, and a wireless network.

The present method and apparatus are not limited to the particular details of the depicted embodiments and other modifications and applications are contemplated. Certain other changes may be made in the above-described embodiments without departing from the true spirit and scope of the present method and apparatus herein involved. It is intended, therefore, that the subject matter in the above depiction shall be interpreted as illustrative and not in a limiting sense.

We claim:

1. An apparatus, comprising:
a burst functionality whereby a foremost coupon is separated from a next coupon of a continuous web of coupons;
a staging functionality whereby the separated foremost coupon is moved to a staging position; and
an insertion functionality whereby the first coupon is inserted into a container only after the next coupon is separated from the continuous web.

2. The apparatus according to claim 1, wherein the apparatus further comprises:
a positioning roll pair that defines a bight to receive a leading edge of the foremost coupon of the continuous web;
a feeding roll assembly located upstream of the positioning roll pair; and
a controller operatively coupled to the positioning roll pair and to the feeding roll assembly.

3. The apparatus according to claim 2, wherein the burst functionality controls the positioning roll pair and to the feeding roll assembly to separate the foremost coupon from a next coupon of the continuous web.

4. The apparatus according to claim 3, wherein the staging functionality effects movement, by the feeding roll assembly, of the separated foremost coupon to a staging position.

5. The apparatus according to claim 4, wherein the insertion functionality effects insertion of the first coupon into a container only after the next coupon is separated from the continuous web.

6. The apparatus according to claim 1, wherein the coupon comprises a printed item contained in an envelope.

7. The apparatus according to claim 1, wherein the apparatus further comprises a coupon sensing assembly, the coupon sensing assembly having at least a first sensor for use in effecting the burst functionality and for use in effecting the staging functionality.

8. An apparatus, comprising:
a plurality of coupons in a continuous web;
a first and second roller pairs that defines a bight to receive a leading edge of a foremost coupon of the continuous web;
a feeding roll assembly located downstream of the first and second roller pair;
a controller operatively coupled to the first and second roller pair and to the feeding roll assembly;
a burst functionality in the controller whereby the first and second roller pair are controlled to separate the foremost coupon from a next coupon of the continuous web;
a staging functionality in the controller whereby the separated foremost coupon is moved to a staging position by the feeding roll assembly; and
an insertion functionality in the controller whereby the foremost coupon is inserted into a container only after the next coupon is separated from the continuous web.

9. The apparatus according to claim 8, wherein the coupon comprises a printed item contained in an envelope.

10. The apparatus according to claim 8, wherein the feeding roll assembly is driven by an intermittent feeding drive.

11. The apparatus according to claim 8, wherein the apparatus further comprises a coupon sensing assembly operatively coupled to the controller, the coupon sensing assembly having at least a first sensor for use in effecting the burst functionality and for use in effecting the staging functionality.

12. The apparatus according to claim 11, wherein the coupon sensing assembly further comprises a third sensor for detecting the container.

13. A method, comprising:
bursting a foremost coupon from a next coupon of a continuous web of coupons;
moving the separated foremost coupon to a staging position; and
inserting the first coupon into a container only after the next coupon is separated from the continuous web.

14. The method according to claim 13, wherein the bursting of the foremost coupon from the next coupon of the continuous web of coupons is effected by a first roller pair that is driven by an intermittent feeding drive at a an intermittent speed that is less than a speed of a second roller pair.

15. The method according to claim 14, wherein the method further comprises:
sensing a presence of the foremost coupon at a bight area, the bight area defined by locations of the first and second roller pairs, where the foremost coupon is burstable from the next coupon of the continuous web of coupons.

16. The method according to claim 13, wherein the moving of the separated foremost coupon to a staging position is effected by a feeding roll assembly located upstream of the first and second roller pair.

17. The method according to claim 16, wherein the method further comprises:
sensing a presence of the separated foremost coupon at a staging position.

18. The method according to claim 17, wherein the method further comprises:
sensing a presence of the container at a predetermined location relative to the staging position.

19. The method according to claim 17, wherein the method further comprises:
ejecting the foremost coupon from the feeding roll assembly such that the foremost coupon is inserted into the container, wherein the container is moving at a predetermined speed.

20. The method according to claim 13, wherein the coupon comprises a printed item contained in an envelope.

21. A method, comprising:
feeding a coupon web between a first roller pair until a leading edge of the coupon web reaches a bight area between the first roller pair and a second roller pair;
during on-going operation a foremost coupon being at a staging position within a feeding roll assembly that is downstream from the first and second roller pairs, and a next coupon of the coupon web being at the bight area;
detecting an approaching container;
activating the first and second roller pairs and the feeding roll assembly;
moving the foremost coupon through the feeding roll assembly while moving the next coupon into the second roller pair;
separating the next coupon from the coupon web in a burst operation using the first and second roller pairs; and
inserting the foremost coupon into the container after the next coupon has been separated from the coupon web, the next coupon being moved to the staging position in the feeding roll assembly.

22. The method according to claim 21, wherein during the burst operation a speed of the first roller pair is at least slowed relative to a speed of the second roller pair to thereby separate a coupon from the coupon web.

23. An apparatus, comprising:
means for feeding a coupon web between a first roller pair until a leading edge of the coupon web reaches a bight area between the first roller pair and a second roller pair;
during on-going operation a foremost coupon being at a staging position within a feeding roll assembly that is downstream from the first and second roller pairs, and a next coupon of the coupon web being at the bight area;
means for detecting an approaching container;
means for activating the first and second roller pairs and the feeding roll assembly;
moving the foremost coupon through the feeding roll assembly while moving the next coupon into the second roller pair;
means for separating the next coupon from the coupon web in a burst operation using the first and second roller pairs; and
means for inserting the foremost coupon into the container after the next coupon has been separated from the coupon web, the next coupon being moved to the staging position in the feeding roll assembly.

24. The apparatus according to claim 23, wherein the apparatus further comprises, during the burst operation, means for at least slowing a speed of the first roller pair relative to a speed of the second roller pair to thereby separate a coupon from the coupon web.
